(19) United States
(12) Patent Application Publication
(10) Pub. No.: US 2010/0045101 A1
(43) Pub. Date: Feb. 25, 2010

(54) DEACTIVATING A SAFETY FUNCTION BY BRAKING

(76) Inventor: Stephen Stabrey, Stuttgart (DE)

Correspondence Address: KENYON & KENYON LLP, ONE BROADWAY, NEW YORK, NY, 10004, US

(21) Appl. No.: 12/225,894

(22) PCT Filed: Mar. 23, 2007
(86) PCT No.: PCT/EP2007/052795

§ 371 Date: Aug. 31, 2009

(30) Foreign Application Priority Data
Apr. 3, 2006 (DE) 102006015488.6

(51) Int. Cl. B60T 8/32

(52) U.S. Cl. 303/191

(57) ABSTRACT

A method for deactivating a safety function, in which the deactivation is implemented as a function of a braking operation implemented by the driver.

### BACKGROUND INFORMATION

German Patent No. DE 10 2004 038 734 describes a method and a device for triggering an emergency braking operation of a vehicle in order to avoid a collision or in order to reduce the severity of the collision. Here, an automatic emergency braking operation is triggered as a function of a determined collision probability.

### SUMMARY OF THE INVENTION

The present invention relates to a method for deactivating a safety function, in which the deactivation takes place as a function of a braking operation implemented by the driver. This enables the driver to signal to the safety system, via an activation of the brake pedal implemented by the driver himself, that he wishes to reacquire control of the vehicle.

One advantageous development of the present invention is characterized by a termination of the safety function if the braking intensity specified by the driver exceeds a specified threshold value, i.e., if the driver brakes to a sufficient degree. This prevents an accidental deactivation of the safety function in an unintentionally weak actuation of the brake pedal by the driver.

One advantageous development of the present invention is characterized by the fact that the activated safety function implements a driver-independent braking operation.

One advantageous development of the present invention is characterized by the fact that the safety function is terminated if the braking pressure specified by the driver or the braking pressure corresponding to the brake-pedal position is greater than the braking pressure currently generated by the safety function, or if it is greater than a specified component or greater than a specified multiple of the braking pressure currently generated by the safety function. “Specified multiple” in this context could also mean, for instance, 1.5 times the braking pressure currently generated by the safety function, i.e., there is no restriction to whole numbers.

One advantageous development of the present invention is characterized by the fact that the safety function is an automatic emergency braking operation.

One advantageous development of the present invention is characterized by the fact that the safety function is an automatic emergency braking operation following a collision that has occurred.

One advantageous development of the present invention is characterized by the fact that the safety function involves an automatic emergency braking operation following collision that was detected as imminent, or following the detection of an imminent collision.

Furthermore, the present invention includes a device having means for implementing the methods according to the present invention.

### BRIEF DESCRIPTION OF THE DRAWINGS

FIG. 1 shows an embodiment of the system according to the present invention.

FIG. 2 shows a graph of braking pressure vs. time.

FIG. 3 shows an embodiment of the method according to the present invention.

### DETAILED DESCRIPTION

Current safety systems usually cannot be overruled. Overrule concepts are required to enable the introduction of new safety systems on the market. It is an object of the present invention to give the driver the option of overruling a system that triggers an automatic braking operation.

Known strategies for deactivating vehicle systems such as ACC address “normal” driving situations in which corresponding driver-related operating variables are to be expected. However, if a safety function that intervenes in an emergency situation is to be examined, other responses on the part of the driver must be expected. A light actuation of the brake pedal, in particular, is unsuitable as an indicator for the deactivation of a braking intervention implemented independently of the driver.

A core of the present invention is to terminate an automatic braking operation of a safety system only if the braking pressure (or a corresponding substitute variable) specified by the driver via the brake pedal exceeds a specified component or a specified multiple of the braking pressure applied by the safety function.

After detecting a light collision, for instance, a safety function triggers a full braking operation in order to reduce the severity of an imminent subsequent collision. However, the braking operation may also be triggered on the basis of an environment sensor system for avoiding accidents.

Due to the deactivation strategy according to the present invention, the automatically triggered braking operation is ended only if the driver himself brakes heavily (FIG. 2, area b)). This may be characterized by the fact that, for instance, the braking pressure specified by the driver is greater than the braking pressure currently generated by the safety function (as illustrated in FIG. 2 for the case of k=1). The deactivation of the safety function therefore takes place only if the driver himself is able to bring about a corresponding vehicle deceleration and thus does not require the system's support.

Due to this strategy, the deactivation therefore has no or only negligible effects on the vehicle movement since the braking action initially generated by the system is continued by the driver. Nevertheless, the driver is given full control again, so that he is able to selectively influence the vehicle speed by, for instance, reducing the braking pressure. This deactivation criterion may be linked to other deactivation criteria, e.g., situation-dependent criteria, to generate a deactivation decision.

In an emergency situation, accidental pedal actuations may occur as a result of passenger movements. If the driver, for instance, has his foot above the brake pedal at the instant of the automatically triggered braking operation, then the forward shift of the passengers caused by the deceleration may result in a pedal actuation (FIG. 2, area a)), which cannot be interpreted as an indication of intentional braking. This pedal actuation is considerably lower than the braking pressure specified by the system, so that it will not lead to a deactivation of the safety function, and the safety function is therefore able to support the driver in an optimal manner.

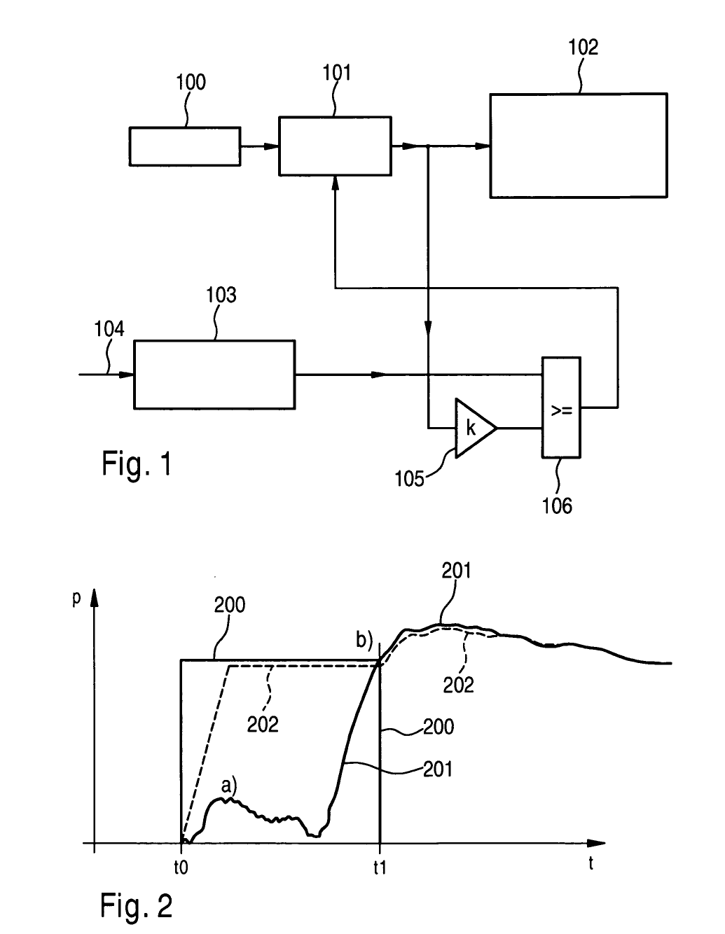

The configuration of the present invention is represented in FIG. 1. There, a safety function 101 is activated as a function of the output signals of sensors 100. The safety function transmits a braking request to brake system 102, which thereupon activates the vehicle brakes.

At the same time, using a sensor 103 which is designed as a brake-pedal sensor, for instance, a braking intention or a brake-pedal actuation by driver 104 is detected. This braking intention is forwarded to a comparator 106. This comparator compares the intensity of this braking intention of the driver to the intensity of the braking operation implemented by the safety function, the intensity of the braking operation carried out by the safety function having previously been multiplied by a factor k in block 105. If the intensity of the driver-desired braking is greater than the intensity of the braking operation implemented by the safety function multiplied by factor k, then a signal is forwarded to block 101, thereby deactivating the driver-independent braking operation implemented in block 102.

In FIG. 2, time t is plotted in the abscissa direction, and braking pressure p in the ordinate direction. 200 denotes the driver-independent braking pressure requested by the safety function. At time t0, a driver-independent braking operation is implemented, in response to an occurring event, which, for instance, may involve a detected collision or an impending collision. In FIG. 2, this manifests itself by the direct increase in requested braking pressure 200.

201 denotes the driver-dependent braking pressure that corresponds to an activation of the brake pedal by the driver. Dashed profile 202 denotes the effective braking pressure. The ramp-like characteristic following t0 is due to the fact that the braking pressure requested by the safety function cannot be generated instantaneously. At time t0, the driver lightly actuates the brake pedal, which can be inferred from the section of curve 201 denoted by a).

This light actuation is followed by a strong actuation; at time t1, the braking pressure corresponding to the brake-pedal actuation is equal to the braking pressure generated independently of the driver. This is taken as a sign that the driver is in control of the current situation and as a criterion that the driver-independent braking operation may be terminated. The driver-independent braking operation is then terminated, which can be inferred from the direct reduction in brake-pressure request 200 of the safety function. The driver thus reacquires full control over the vehicle.

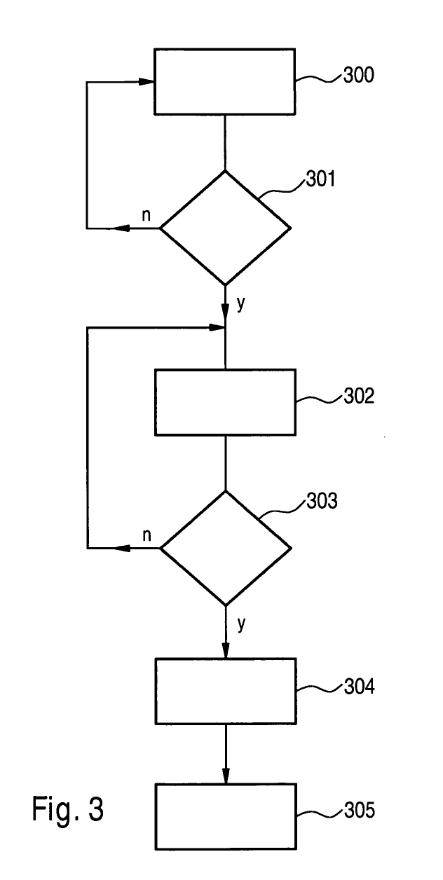

The sequence of the method according to the present invention is shown in FIG. 3. Following the start of the method in block 300, a query as to whether the activation condition for the safety function has been satisfied takes place in block 301. If it has not been satisfied, a return to block 300 takes place. On the other hand, if it has been satisfied, a safety measure assigned to the activated safety function is triggered in block 302, e.g., a driver-independent braking operation. It is then queried in block 303 whether a deactivation condition for the safety function has been satisfied by the driver. If this is not the case, then a return to block 302 takes place. However, if the deactivation condition has been satisfied, the safety function is subsequently deactivated in block 304. The method ends in block 305.

1-9. (canceled)

10. A method for deactivating an activated safety function in a vehicle, the method comprising:
deactivating the safety function as a function of a braking operation implemented by a driver of the vehicle.

11. The method according to claim 10, further comprising terminating the safety function if a braking intensity specified by the driver exceeds a specified threshold value.

12. The method according to claim 10, wherein the activated safety function implements a driver-independent braking operation.

13. The method according to claim 12, further comprising terminating the safety function if a braking pressure specified by the driver is greater than a braking pressure currently generated by the safety function, or if it is greater than a specified component or greater than a specified multiple of the braking pressure currently generated by the safety function.

14. The method according to claim 10, wherein the safety function is an automatic emergency braking operation.

15. The method according to claim 10, wherein the safety function is an automatic emergency braking operation following a collision that has occurred.

16. The method according to claim 10, wherein the safety function is an automatic emergency braking operation following a detection of an imminent collision.

17. The method according to claim 11, wherein the braking intensity specified by the driver is a braking intensity that corresponds to a brake-pedal position.

18. A device for deactivating an activated safety function in a vehicle, comprising:
means for deactivating the safety function as a function of a braking operation implemented by a driver of the vehicle.
